(19) United States
(12) Patent Application Publication
(10) Pub. No.: US 2019/0389273 A1
(43) Pub. Date: Dec. 26, 2019

(54) CONNECTION STRUCTURE FOR ASSEMBLING AN HVAC HOUSING WITH DIVIDER FOR MULTIPLE ZONES

(71) Applicant: Calsonic Kansei North America Inc., Farmington Hills, MI (US)

(72) Inventors: Silvia Denisse Vazquez Salazar, Farmington Hills, MI (US); Christopher Lynn Dawson, Westland, MI (US)

(21) Appl. No.: 16/014,150

(22) Filed: Jun. 21, 2018

(51) Int. Cl. B60H 1/00

(52) U.S. Cl. CPC B60H 1/00064; B60H 1/00514; B60H 1/00028; B60H 2001/00185; B60H 1/00564

(57) ABSTRACT

A housing assembly for an HVAC system includes a first shell having a first boss having a first bore configured to receive a fastener therein. The housing assembly further includes a second shell having a second boss having a second bore. The housing assembly further includes a divider disposed between the first shell and the second shell, the divider having a divider bore configured to receive the first boss therein and a divider counterbore configured to receive the second boss therein. A diameter of the divider bore is less than a diameter of the divider counterbore. The divider bore and the divider counterbore are coaxial and configured to receive the fastener extending therethrough.

### BACKGROUND

The present application relates generally to the field of heating, ventilation, and air conditioning (“HVAC”) systems for vehicles, and more particularly to connection structures for assembling a housing for HVAC systems having more than one zone.

A conventional HVAC system with more than one zone provides air to different portions of the vehicle passenger compartment at different temperatures. In order to provide air at more than one temperature, the HVAC system may be subdivided into different zones by installing a divider inside an HVAC housing and providing separate zones on each side of the divider. Generally, the installation of the divider in the housing greatly increases the complexity of not only the HVAC system itself, but the process of assembling the HVAC system. For example, the HVAC system requires additional structure to hold the divider in place. Furthermore, separate shell components forming the housing are separately coupled to each side of the divider. During assembly, one shell component may be coupled to a first side of the divider, the divider is then flipped over, and then a second shell component may be coupled to an opposing second side of the divider. This structure and assembly process requires additional steps and time associated with rotating the HVAC system in order to provide access to fasten shell components to both sides of the divider.

It would therefore be advantageous to provide an HVAC system with a divider and separate opposing shell components that may be coupled to the divider from a first direction without flipping the divider or the rest of the HVAC system.

### SUMMARY

One embodiment relates to a housing assembly for an HVAC system including a first shell having a first boss having a first bore configured to receive a fastener therein. The housing assembly further includes a second shell having a second boss having a second bore. The housing assembly further includes a divider disposed between the first shell and the second shell, the divider having a divider bore configured to receive the first boss therein and a divider counterbore configured to receive the second boss therein. A diameter of the divider bore is less than a diameter of the divider counterbore. The divider bore and the divider counterbore are coaxial and configured to receive the fastener extending therethrough.

Another embodiment relates to a housing assembly for an HVAC system including a first shell having a first boss, a second shell having a second boss, and a divider disposed between the first shell and the second shell, the divider having a divider flange defining a divider bore and a divider counterbore. One of the divider bore or divider counterbore is configured to receive the first boss, and the other of the divider bore or the divider counterbore is configured to receive the second boss. A diameter of the divider bore is less than a diameter of the divider counterbore. The divider bore and the divider counterbore are coaxial and configured to receive a fastener extending therethrough.

Another embodiment relates to a method of assembling an HVAC system including positioning a divider on a first shell, the first shell defining a first boss, and positioning a second shell on the divider opposing the first shell, the second shell having a second boss. The method further includes inserting a fastener through the second boss then into the first boss, and coupling the first shell, the divider, and the second shell with the fastener. A diameter of the divider bore is less than a diameter of the divider counterbore. The divider bore and the divider counterbore are coaxial and configured to receive the fastener extending therethrough.

### BRIEF DESCRIPTION OF THE DRAWINGS

FIG. 1 is an exploded view of a housing assembly for a vehicle HVAC system, according to an exemplary embodiment.

FIG. 2 is a cross-sectional exploded view of a portion of the housing assembly of FIG. 1.

FIG. 2A is a close-up view of a portion of FIG. 2.

FIG. 3 is a cross-sectional assembled view of the portion of the housing assembly of FIG. 2, showing a divider installed between upper and lower shells.

FIG. 3A is a close-up view of a portion of FIG. 3.

FIG. 4 is an exploded partial view of a housing assembly with a prior art connection structure.

FIG. 5 is an exploded view of the housing assembly of FIG. 1, showing a connector assembly according to an exemplary embodiment.

FIG. 6 is a cross-sectional view of the exploded connector assembly shown in FIG. 5.

FIG. 7 is a cross-sectional view of the connector assembly of FIG. 5 in a partially-assembled configuration.

FIG. 8 is a cross-sectional view of the connector assembly of FIG. 5 in a fully-assembled configuration.

FIG. 9 is a perspective view of an HVAC system showing a heater being installed in the housing assembly according to an exemplary embodiment.

### DETAILED DESCRIPTION

Referring to the FIGURES generally, an HVAC system for a vehicle is shown according to various exemplary embodiments. The HVAC system is shown as a multi-zone system for providing air to different portions of a vehicle passenger compartment at different temperatures. While the FIGURES show the HVAC system as a housing assembly with a heater disposed therein and configured to control the distribution of air to different parts of the passenger compartment, it should be understood that the HVAC system may include a blower and an evaporator positioned upstream from the housing assembly and configured to control the flow rate and the temperature, respectively, of the air supplied to the housing assembly.

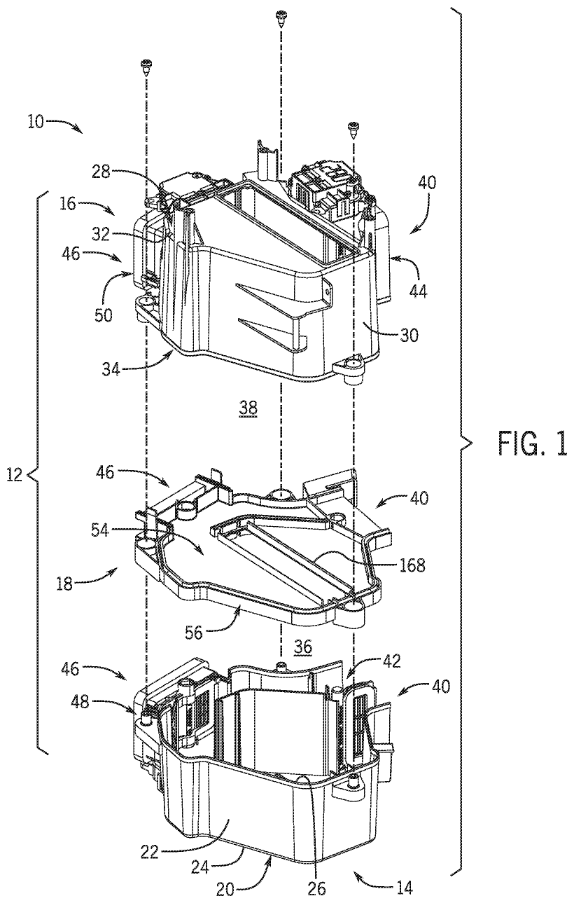

Referring to FIG. 1, an HVAC system 10 is shown according to an exemplary embodiment. The HVAC system 10 includes a housing assembly 12 having a lower (i.e., first, rear, etc.) shell 14 (i.e., case, body, component, section, etc.), an upper (i.e., second, forward, etc.) shell 16, and a divider 18 disposed therebetween. It should be understood that, as described herein, the terms “lower” and “upper” do not limit the orientation of the housing assembly 12 and that the lower shell 14 and other lower surfaces may be positioned above the upper shell 16 and other upper surfaces or in other directions. The lower shell 14 includes a lower surface 20 and lower sidewalls 22 extending from an outer periphery 24 of the lower surface 20. The lower sidewalls 22 extend upward away from and generally perpendicular (i.e., orthogonal) to the lower surface 20 and define an upper edge 26 opposite from the lower surface 20. Similarly, the upper shell 16 includes an upper surface 28 and upper sidewalls 30 extending from an outer periphery 32 of the upper surface 28. The upper sidewalls 30 extend downward away from and generally perpendicular to the upper surface 28 and define a lower edge 34 opposite from the upper surface 28. The upper edge 26 of the lower sidewalls 22 defines a complementary profile substantially similar to or the same as the lower edge 34 of the upper sidewalls 30. In this configuration, when the housing assembly 12 is fully assembled, substantially an entire interior volume of the housing assembly 12 is disposed within the upper and lower sidewalls 30, 22 and the upper and lower surfaces 28, 20.

The divider 18 is disposed between the lower shell 14 and the upper shell 16 and is configured to divide the housing assembly 12 into more than one zone. A first zone 36, configured to provide air to a first portion of the passenger compartment at a first temperature is defined between the divider 18 and the lower shell 14. Similarly, a second zone 38, configured to provide air to a second portion of the passenger compartment, is defined between the divider 18 and the upper shell 16. In this configuration, the divider 18 separates flow received at a housing inlet 40 of the housing assembly 12 into separate streams in each of the first and second zones 36, 38. The second zone 38 may be configured to output air at the first temperature. According to another exemplary embodiment, a heater (e.g., a PTC heater) may be disposed in each of the first and second zones 36, 38 and configured to heat air in the second zone 38 to a second temperature different from the first temperature. The housing inlet 40 is formed from a lower housing inlet 42 defined in the lower shell 14 and an upper housing inlet 44 defined in the upper shell 16. When the housing assembly 12 is fully assembled, the lower and upper housing inlets 42, 44 may form one singular housing inlet 40, such that a single stream received at the housing inlet 40 is split into two separate streams downstream from the housing inlet 40. According to another exemplary embodiment, the divider 18 may extend into the housing inlet 40, such that the divider 18 separates the housing inlet 40 into each of the lower housing inlet 42 and the upper housing inlet 44 and therefore into two separate streams directly at the housing inlet 44.

During operation of the HVAC system 10, the divider 18 maintains these separate streams during their respective heating, such that each zone 36, 38 may be heated to different temperatures. The divider 18 further extends to a housing outlet 46. The housing outlet 46 is formed from a lower housing outlet 48 defined in the lower shell 14 and an upper housing outlet 50 defined in the upper shell 16. When the housing assembly 12 is fully assembled, the divider 18 maintains the two separate streams at the housing outlet 46, separately outputting a first stream from the first zone 36 between the divider 18 and the lower housing outlet 48, and a second stream from the second zone 38 between the divider 18 and the upper housing outlet 50.

According to another exemplary embodiment, the first and second zones 36, 38 may output air at different volume flow rates, such that the first zone 36 provides air to the passenger compartment at a first flow rate and the second zone 38 provides air to the passenger compartment at a second flow rate different from the first flow rate. The flow rate in each of the first and second zones 36, 38 may be controlled by decreasing the cross-sectional area (e.g., with a door) at a location between the housing inlet 40 and the housing outlet 46. In this configuration, the HVAC system 10 may provide different flow rates of air to different portions of a vehicle while operating a single blower at a single rotational speed.

While FIG. 1 shows the housing assembly 12 having one divider 18 separating the housing assembly 12 into two zones 36, 38, according to other exemplary embodiments, the housing assembly 12 may define more zones. For example, additional dividers may be disposed between the lower shell 14 and the upper shell 16, substantially parallel to the divider 18 shown in FIG. 1. Each additional divider may correspond to an additional zone (e.g., a housing assembly 12 with two dividers corresponds to three zones, a housing assembly 12 with three dividers corresponds to four zones, etc.). The additional zones are then defined between adjacent dividers and may provide air to different portions of the passenger compartment at different temperatures and/or volume flow rates.

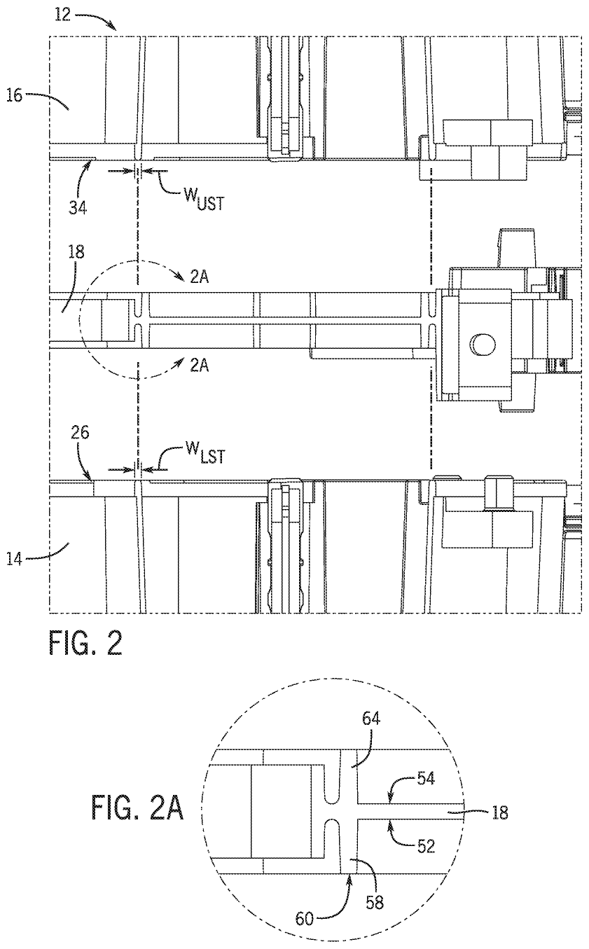

Referring still to FIG. 1, the divider 18 will be described in further detail. The divider 18 is substantially planar and defines a lower surface 52 (i.e., a first surface, shown in FIG. 2A) facing the lower shell 14 and an opposing upper surface 54 (i.e., a second surface) facing the upper shell 16. The divider 18 defines an outer periphery 56 having a profile that is substantially the same as and complementary to the upper edge 26 of the lower sidewalls 22 and the lower edge 34 of the upper sidewalls 30. The upper edge 26 of the lower sidewalls 22 and the lower edge 34 of the upper sidewalls 30 are each configured to nest with the outer periphery 56 of the divider 18 when the housing assembly 12 is in an assembled configuration.

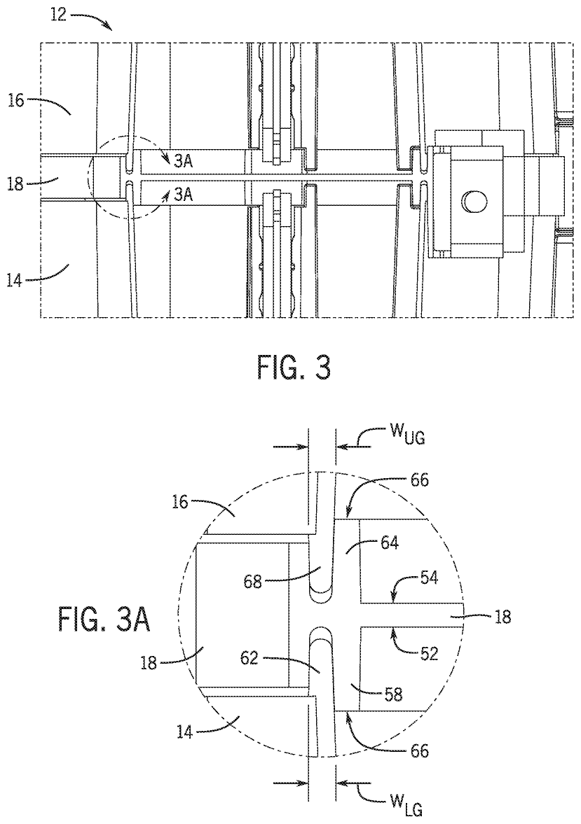

Referring now to FIGS. 2 and 2A, a partial cross-sectional exploded view of the housing assembly 12 is shown according to an exemplary embodiment. The housing assembly 12 includes a tongue-and-groove configuration for connecting for coupling the upper and lower shells 16, 14 to the divider 18. Specifically, as shown in FIG. 2A, a divider lower wall 58 extends substantially perpendicular to and away from the lower surface 52 of the divider 18 at the outer periphery 56. A divider lower edge 60 is formed at an end of the divider lower wall 58 opposing the lower surface 52 and a lower groove (i.e., channel) 62 is defined in the divider lower edge 60, extending substantially perpendicular to the lower surface 52 and into the divider lower wall 58. Referring to FIGS. 3 and 3A, the lower groove 62 defines a lower groove width W_{LG}. Similarly, a divider upper wall 64 extends substantially perpendicular to and away from the upper surface 54 of the divider 18 at the outer periphery 56. A divider upper edge 66 is formed at an end of the divider upper wall 64 opposing the upper surface 54 and an upper groove (i.e., channel) 68 is defined in the divider upper edge 66, extending substantially perpendicular to the upper surface 54 and into the divider upper wall 64. The upper groove 68 defines an upper groove width W_{UG}, which may be substantially the same as the lower groove width W_{LG} or, according to other exemplary embodiments, may be different from the lower groove width W_{LG}.

Referring now to FIGS. 2-3A, the upper edge 26 of the lower shell 14 is a tongue (i.e., a lower shell tongue), which is configured to be inserted into and received in the lower groove 62 of the divider 18. The upper edge 26 defines a substantially constant lower shell tongue width W_{LST}. The lower shell tongue width W_{LST} may be approximately the same as the lower groove width W_{LG}, such that when the upper edge 26 is received in the lower groove 62, lateral movement (e.g., rotation, translation, etc.) of the divider 18 relative to the lower shell 14 is limited. According to an exemplary embodiment, the lower shell tongue width W_{LST} may be substantially the same as or greater than the lower groove width W_{LG}, such that the upper edge 26 is press-fit in the lower groove 62.

Similarly to the lower shell 14, the lower edge 34 of the upper shell 16 is a tongue (i.e., an upper shell tongue), which is configured to be inserted into and received in the upper groove 68 of the divider 18. The lower edge 34 defines a substantially constant upper shell tongue width W_{UST}. The upper shell tongue width W_{UST} may be approximately the same as the upper groove width W_{UG}, such that when the upper edge 34 is received in the upper groove 68, lateral movement (e.g., rotation, translation, etc.) of the divider 18 relative to the upper shell 16 is limited. According to an exemplary embodiment, the upper shell tongue width W_{UST} may be substantially the same as or greater than the upper groove width W_{UG}, such that the lower edge 34 is press-fit in the upper groove 68.

As shown in FIG. 2A, the divider lower wall 58 and the divider upper wall 64 may be substantially coplanar, although according to other exemplary embodiments, the divider lower wall 58 and the divider upper wall 64 may be offset from each other, such that the divider lower wall 58 is configured to align with a corresponding tongue in the lower shell 14 and the divider upper wall 64 is configured to align with a corresponding tongue in the upper shell 16.

While FIGS. 2-3A show the divider 18 defining lower and upper grooves 62, 68 and the lower and upper shells 14, 16 defining tongues received in the grooves 62, 68, according to other exemplary embodiments, the housing assembly 12 may provide another tongue-and-groove arrangement. For example, the divider lower edge 60 may define a tongue and the upper edge 26 of the lower shell 14 may define a groove configured to receive the divider lower edge 60. Similarly, the divider upper edge 66 may define a tongue and the lower edge 34 of the upper shell 16 may define a groove configured to receive the divider upper edge 66.

According to yet another exemplary embodiment, one of the divider lower edge 60 or the divider upper edge 66 may define a tongue configured to be received in a corresponding groove and the other of the divider lower edge 60 or the divider upper edge 66 may define a groove configured to receive a corresponding tongue. In this configuration, one of the upper edge 26 of the lower shell 14 or the lower edge 34 of the upper shell 16 defines a tongue structure and the other defines a groove, such that the two-zone HVAC system 10 may be assembled as a single-zone system without the divider 18 disposed therebetween and the same lower and upper shells 14, 16 are adaptable for use in a single-zone system.

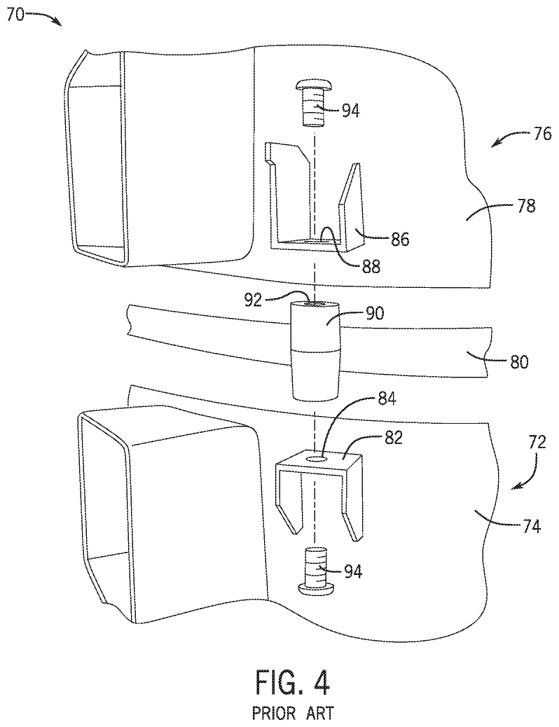

Referring now to FIG. 4, an exploded view of a prior art HVAC system 70 is shown. The HVAC system 70 includes a lower shell 72 defining a lower outer surface 74, an upper shell 76 defining an upper outer surface 78, and a divider 80 disposed therebetween. A lower flange 82 extends from the lower outer surface 74 and defines a lower flange bore 84 defining a longitudinal axis substantially perpendicular to the divider 80. An upper flange 86 extends from the upper outer surface 78 and defines an upper flange bore 88 defining a longitudinal axis substantially perpendicular to the divider 80. A boss 90 extends laterally outwardly from the divider 80 and defines a boss bore 92 extending therethrough defining a longitudinal axis. During assembly, the longitudinal axes of each of the lower flange bore 84, upper flange bore 88, and the boss bore 92 are substantially aligned (i.e., coaxial, collinear, etc.). The boss bore 92 is internally threaded and configured to receive fasteners 94 therein. During assembly of the prior art HVAC system 70, the lower and upper shells 72, 76 are brought into engagement with opposing sides of the divider 80. The lower and upper flange bores 84, 88 must be carefully aligned with the boss bore 92. Without any corresponding locating features between the divider 80 and each of the lower and upper shells 72, 76, the HVAC system 80 requires additional equipment to hold each of the components in place as the fasteners 94 are installed in the corresponding bores.

Further, as shown in FIG. 4, the fasteners 94 are inserted into opposing sides of the boss bore 92 for retention therein. Specifically, one of the fasteners 94 is fed through the lower flange bore 84 and is threaded into the boss bore 92. The other fastener 94 is then fed through the upper flange bore 88 and threaded into the opposing side of the boss bore 92. In this configuration, an operator (i.e., installer) assembling the HVAC system 70 generally must flip the partially-assembled HVAC system 70 over partway through assembly, in order to more easily install the fasteners 94 in the same downward direction. This assembly configuration may require the realignment of the upper or lower shell 76, 72 with the divider 80 after the partially-assembled HVAC system 70 is flipped. Alternatively, the operator must move around the HVAC system 70 in order to access each side of the boss 90. In each assembly configuration, additional labor is required in order to insert the fasteners 94 in opposing directions, increasing operator fatigue, time, cost, and/or complexity of the assembly process.

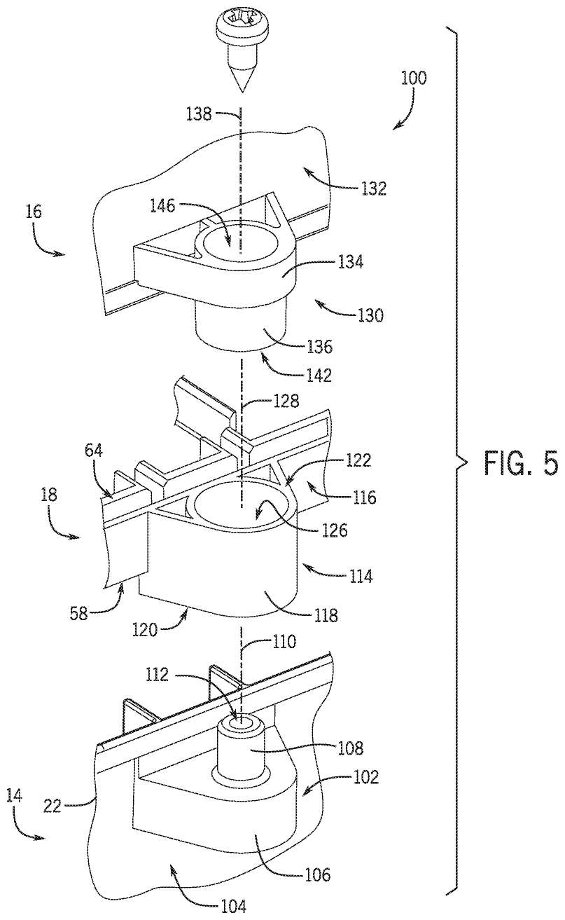

Referring generally to FIGS. 5-9, the HVAC system 10 described in FIGS. 1-3A is shown with a connector assembly 100 according to an exemplary embodiment. Specifically, referring to FIG. 5, the connector assembly 100 includes a lower (i.e., first) connector structure 102 extending from an outer surface 104 (i.e., a lower outer surface) of the lower shell 14. The lower connector structure 102 includes a lower (i.e., first) flange 106, which extends laterally outward (e.g., perpendicularly away) from the lower outer surface 104. A lower (i.e., first) boss 108, having a substantially circular cross-sectional outer profile, extends generally upward and away from the lower flange 106, defining a longitudinal axis 110 extending therethrough. The lower boss 108 further defines a lower (i.e., first) bore 112 formed annularly about the longitudinal axis 110 and configured to receive a fastener therein. The lower boss 108 and therefore the longitudinal axis 110 extend substantially parallel to the lower sidewalls 22.

It should be further understood that the term “upward” as described herein refers to the direction moving away from the lower shell 14 toward the upper shell 16, generally perpendicular to the planar orientation of the divider 18. Similarly, the term “downward” as described herein refers to the direction moving away from the upper shell 16 toward the lower shell. It should be understood that the lower shell 14, the upper shell 16, and the divider 18 may be oriented in other directions, such that the “upward” and “downward” directions are not fixed relative to the ground.

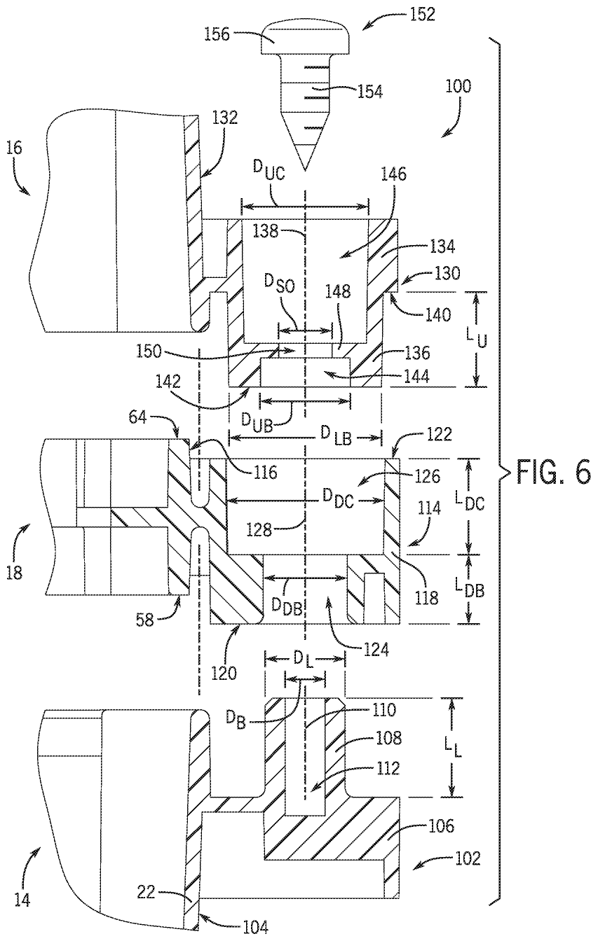

Referring to FIGS. 5 and 6, the connector assembly 100 further includes a divider connector structure 114 extending from an outer surface 116 (i.e., a divider outer surface) of the divider 18. The divider connector structure 114 includes a divider flange 118, which extends laterally outward (e.g., perpendicularly away) from the divider outer surface 116. The divider flange 118 defines a lower surface 120 (e.g., proximate the divider lower wall 58) and an opposing divider upper surface 122 (e.g., proximate the divider upper wall 64). A divider bore 124 is defined in the divider flange 118 and extends generally upward from the divider lower surface 120 into the divider flange 118. A divider counterbore 126 is defined in the divider flange 118 and extends generally downward from the divider upper surface 122 into the divider flange 118 and opening into the divider bore 124. The divider bore 124 and the divider counterbore 126 are formed annularly about and define a longitudinal axis 128 extending therethrough, which is configured to be aligned (e.g., coaxial, collinear, etc.) with the longitudinal axis 110 extending through the lower boss 108. In the configuration shown in FIG. 5, the longitudinal axis 128 extends substantially parallel to the divider outer surface 116.

Referring still to FIGS. 5 and 6, the connector assembly 100 further includes an upper (i.e., second) connector structure 130 extending from an outer surface 132 (i.e., an upper outer surface) of the upper shell 16. The upper connector structure 130 includes an upper (i.e., second) flange 134, which extends laterally outward (e.g., perpendicularly away) from the upper outer surface 132. An upper (i.e., second) boss 136, having a substantially circular cross-sectional outer profile, extends generally downward and away from the upper flange 134, defining a longitudinal axis 138 extending therethrough. The upper boss 136 includes an upper end 140 defined at the upper flange 134 and an opposing lower end 142. An upper (i.e., second) bore 144 is defined in the upper boss 136 and extends generally upward from the lower end 142 into the upper boss 136. An upper (i.e., second) counterbore 146 is defined in the upper boss 136 and extends generally downward from the upper flange 134 through the upper boss 136 and opening into the upper bore 144. The upper bore 144 and the upper counterbore 146 are formed annularly about the longitudinal axis 138, which is configured to be aligned (e.g., coaxial, collinear, etc.) with the longitudinal axis 110 extending through the lower boss 108 and the longitudinal axis 128 extending through the divider flange 118. In the configuration shown in FIG. 5, the longitudinal axis 138 extends substantially parallel to the upper outer surface 132.

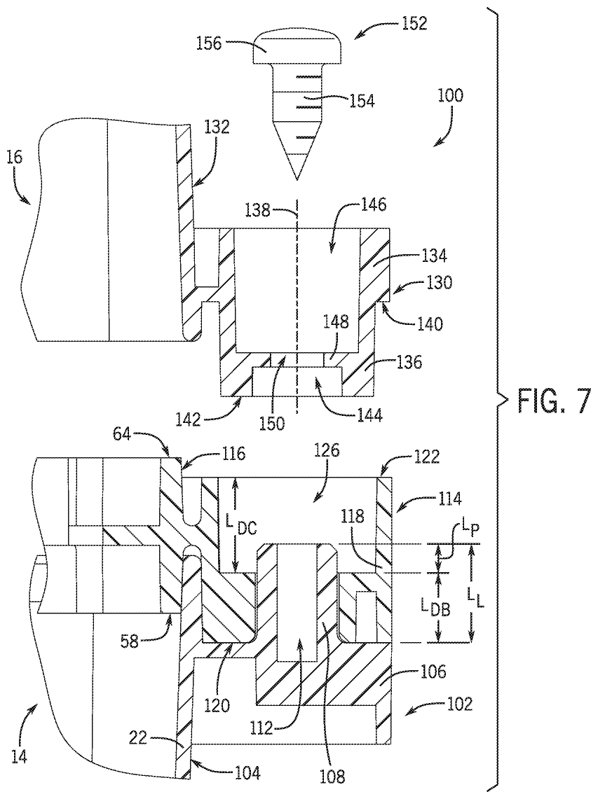

Referring to FIG. 6, the connector assembly 100 is shown in further detail. The lower boss 108 defines a lower boss outer diameter D_{L} and a lower boss length L_{L}, measured from the lower flange 106 to an opposing end of the lower boss 108. The divider bore 124 defines a divider bore diameter D_{DB}, which is substantially the same as or greater than the lower boss outer diameter D_{L}, such that the lower boss 108 is configured to be received in the divider bore 124. According to another exemplary embodiment, the divider bore diameter D_{DB} may be substantially the same as or less than the lower boss outer diameter D_{L}, such that the lower boss 108 is press-fit in the divider bore 124. The divider bore 124 further defines a divider bore length L_{DB}, measured from the divider lower surface 120 to the divider counterbore 126. As shown in FIG. 7, the divider bore length L_{DB} is less than the lower boss length L_{L}, such that at least a portion of the lower boss 108 is received in the divider counterbore 126 and the upper bore 144 when the lower boss 108 is fully inserted into the divider bore 124. The portion of the lower boss 108 extending into the divider counterbore 126 has a protrusion length L_{P}, which is measured as the lower boss length L_{L}, less the divider bore length L_{DB}. According to another exemplary embodiment, the divider bore length L_{AB} may be substantially the same as or greater than the lower boss length L_{L}.

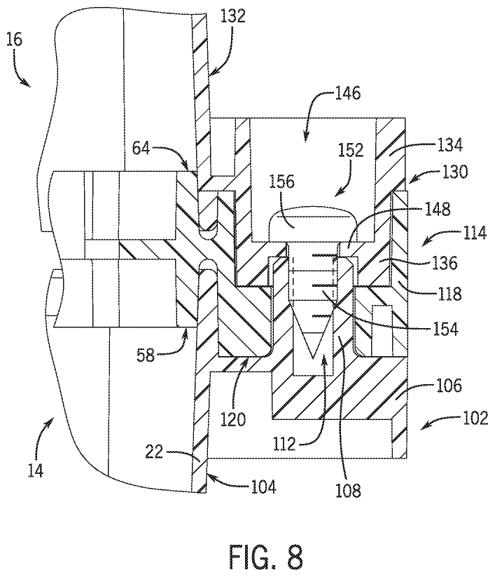

Referring again to FIG. 6, the upper boss 136 defines an upper boss outer diameter D_{U} and an upper boss length L_{U}, measured from the upper end 140 to the lower end 142 of the upper boss 136. The divider counterbore 126 defines a divider counterbore diameter D_{DC}, which is substantially the same as or greater than the upper boss outer diameter D_{U}, such that the upper boss 136 is configured to be received in the divider counterbore 126. According to another exemplary embodiment, the divider counterbore diameter D_{DC} may be substantially the same as or less than the upper boss outer diameter D_{U}, such that the upper boss 136 is press-fit in the divider counterbore 126. The divider counterbore 126 further defines a divider counterbore length L_{DC}, measured from the divider upper surface 122 to the divider bore 124 As shown in FIG. 8, the divider counterbore length L_{DC} is substantially the same as or greater than the upper boss length L_{U}, such that when the upper boss 136 is fully inserted into the divider counterbore 126, the upper flange 134 may be disposed against the divider upper surface 122. According to another exemplary embodiment, the divider counterbore length L_{DC} may be less than the upper boss length L_{U}, such that the upper flange 134 is spaced apart from the divider upper surface 122.

Referring to FIGS. 6-8, the upper bore 144 defines an upper bore diameter D_{UB} and the upper counterbore 146 defines an upper counterbore diameter D_{UC}, which is greater than the upper bore diameter D_{UB}. According to another exemplary embodiment, the upper counterbore diameter D_{UC} may be substantially the same as or less than the upper bore diameter D_{UB}. The upper boss 136 further includes a shoulder 148, which extends radially inward into the upper boss 136 and is formed between the upper bore 144 and the upper counterbore 146. A shoulder opening 150 is defined in the shoulder 148, and annularly about the longitudinal axis 138 extending through the upper boss 136. The shoulder opening 150 extends from the upper bore 144 to the upper counterbore 146 and defines a shoulder opening diameter D_{SO}, which is less than the upper bore diameter D_{UB}.

The upper bore 144 defines an upper bore length L_{UB} measured from the lower end 142 of the upper boss 136 to the shoulder 148. As shown in FIG. 8, the upper bore length L_{UB} may be substantially the same as or less than the protrusion length L_{P} of the lower boss 108, such that the lower boss 108 is configured to be received in the upper bore 144 and seat against the shoulder 148. In this configuration, the upper bore diameter D_{UB} may be substantially the same as or greater than the lower boss outer diameter D_{L}, such that the protruding portion of the lower boss 108 may be received in the upper bore 144. According to another exemplary embodiment, the upper bore diameter D_{UB} may be substantially the same as or less than the lower boss outer diameter D_{L}, such that the lower boss 108 may be press-fit in the upper bore 144.

Referring again to FIG. 6, the connector assembly 100 includes a fastener 152 (e.g., a screw), including a threaded shank 154 and a head 156 having a head diameter D_{H}. As shown in FIG. 8, during assembly, the threaded shank 154 is inserted from the upper counterbore 146, through the shoulder opening 150, and screwed into the lower bore 112 until the head 156 is disposed against the shoulder 148 and the threaded shank 154 threadably engages the lower bore 112. According to an exemplary embodiment, the lower boss 108 is formed from plastic or other material, such that when the fastener 152 is inserted into the lower bore 112, the fastener 152 forms an internal threading in the lower bore 112. According to another exemplary embodiment, the lower bore 112 may already be internally threaded and configured to receive the threaded shank 154 therein.

As shown in FIG. 8, the head diameter D_{H} is greater than the shoulder opening diameter D_{SO}, such that the shoulder 148 is disposed between the lower boss 108 and the head 156. In this configuration, a single fastener 152 couples the lower boss 108 to the upper boss 136. Further, the divider flange 118 is disposed between and engages the lower flange 106 and the upper flange 134, which secures the divider flange and therefore the divider 18 between the lower boss 108 and the upper boss 136 and prevents movement of the divider 18 when the housing assembly 12 is fully assembled.

The interaction between the lower boss 108 and the divider bore 124 is configured to assist an operator in positioning the divider 18 on the lower shell 14. Specifically, the lower boss 108 may be partially inserted into and engage the divider bore 124 while the upper edge 26 of the lower shell 14 is spaced apart from the divider lower edge 60. In this configuration, the divider bore diameter D_{DB} is approximately the same as the lower boss outer diameter D_{L}, and the interaction between the lower boss 108 and the divider bore 124 constrains movement of the divider 18 relative to the lower shell 14 to only an axial direction. Further, a depth of the lower groove 62 formed in the divider lower edge 60 is less than the divider bore length L_{DB}, ensuring that the lower boss 108 is received in the divider bore 124 before the upper edge 26 is received in the lower groove 62.

The interaction between the upper boss 136 and the divider counterbore 126 is configured to assist an operator in positioning the upper shell 16 on the divider 18. Specifically, the upper boss 136 may be partially inserted into and engage the divider counterbore 126 while the lower edge 34 of the upper shell 16 is spaced apart from the divider upper edge 66. In this configuration, the divider counterbore diameter D_{DC} is approximately the same as the upper boss outer diameter D_{U}, and the interaction between the upper boss 136 and the divider counterbore 126 constrains movement of the upper shell 16 relative to the divider 18 to only an axial direction. Further, a depth of the upper groove 68 formed in the divider upper edge 66 is less than the divider counterbore length L_{DC}, ensuring that the upper boss 136 is received in the divider counterbore 126 before the lower edge 34 is received in the upper groove 68.

Advantageously, during assembly of the housing assembly 12, an operator only needs to focus on initially aligning the components of the connector assembly 100 (e.g., the lower boss 108 and the divider bore 124 or the upper boss 136 in the divider counterbore 126), rather than precisely aligning the grooves 62, 68 with their corresponding edges 26, 34. Furthermore, in contrast to the prior art HVAC system shown in FIG. 4, as the divider 18 is brought closer to the lower shell 14, the connector assembly 100 itself maintains the alignment of the divider 18 and the lower shell 14, rather than relying on an operator to hold each of the components in a precise alignment. Similarly, the connector assembly 100 maintains the alignment of the upper shell 16 with the divider 18 and the lower shell 14 as the upper shell 16 is brought closer to the divider 18.

While FIGS. 5-8 show the upper connector structure 130 having both an upper bore 144 and an upper counterbore 146, with the shoulder 148 disposed therebetween, according to another exemplary embodiment the upper connector structure 130 does not include an upper 144. In this configuration, the shoulder 148 is defined at the lower end 142 of the upper boss 136. The lower boss length L_{L} is substantially the same as divider bore length L_{DB}, such that the lower boss 108 is disposed directly against the shoulder 148 at the lower end 142 of the upper boss 136 when the lower boss 108 is fully inserted into the divider bore 124 and the upper boss 136 is fully inserted into the divider counterbore 126. As described above, the shoulder 148 is still disposed between the lower boss 108 and the head 156, such that the divider 18 is constrained in place between the lower connector structure 102 and the upper connector structure 130.

It should be understood that in a configuration in which the housing assembly 12 includes one connector assembly 100, when the divider flange 118 engages the lower boss 108 and the upper boss 136, the divider 18, lower shell 14, and upper shell 16 may be configured to rotate annularly about the longitudinal axes 110, 128, 138, but may not move radially (i.e., translate) relative to the axes. According to another exemplary embodiment, a single connector assembly 100 may be used to locate each of the lower shell 14, upper shell 16, and divider 18 relative to each other and the tongue-and-groove configuration discussed in FIGS. 1-3 may be used to provide the correct rotational orientation of each of the components. Further, each of the components may be freely rotatable when the lower boss 108 is only partially inserted into the divider bore 124 and when the upper boss 136 is only partially inserted into the divider counterbore 126. It should be further understood that while FIGS. 5-8 show the housing assembly 12 with one connector assembly 100, the housing assembly 12 may include more than one (e.g., two, three, etc.) connector assembly 100 according to other exemplary embodiments. In this configuration, two or more connector assemblies 100 coordinate to prevent any rotation of the lower shell 14, upper shell 16, or divider 18 relative to each other, even if the lower bosses 108 and the upper bosses 136 are not fully inserted into the corresponding divider flanges 118.

As shown in FIG. 8, the fastener 152 is configured to be installed in the lower bore 112 along the longitudinal axes 110, 128, 138. Notably, only one fastener 152 is used to couple all three of the lower shell 14, upper shell 16, and divider 18 rather than two opposing fasteners as shown in FIG. 4. By using one fastener 152, the housing assembly 12 may be assembled without reorienting (e.g., moving or flipping over) the housing assembly 12 partway through the assembly process. This configuration reduces the stress on the operator and improves efficiency and cost for assembling the HVAC system 10. Similarly, in a housing assembly 12 with more than one connector assembly 100, each connector assembly 100 includes a (e.g., one) corresponding fastener 152 installed in the same direction (e.g., downward) along a parallel longitudinal axis.

While FIG. 8 shows the fastener 152 being installed in a first, downward direction (i.e., moving from the upper boss 136, downward toward and into the lower boss 108, according to another exemplary embodiment, the fastener 152 may be installed in an opposing second, upward direction. For example, the lower bore 112 may extend fully through the lower boss 108 and the threaded shank 154 is inserted through the lower bore 112 and then the shoulder opening 150. The lower bore 112 defines a lower bore diameter D_{L}, which is greater than a diameter of the threaded shank 154 and the shoulder opening diameter D_{SO} is less than the diameter of the threaded shank 154. In this configuration, the threaded shank 154 threadably engages the shoulder opening 150 and/or a portion of the upper counterbore 146 in the same way as the threaded shank 154 engages the lower bore 112, described above. The head 156 then engages the lower flange 106 or a corresponding counterbore defined in the lower bore 112, substantially similar to the upper counterbore 146.

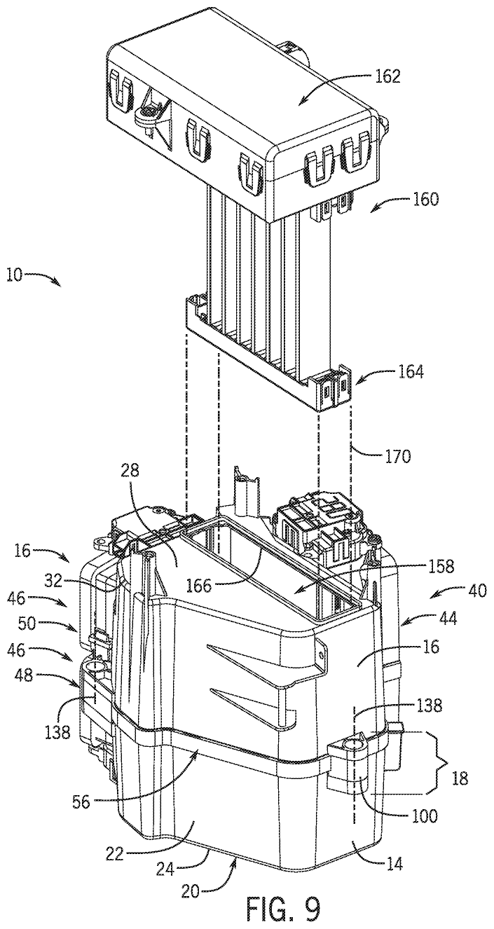

Referring now to FIG. 9, an exploded view of the housing assembly 12 is shown according to an exemplary embodiment. The housing assembly 12 defines a heater channel 158 configured to receive a heater 160 therein. The heater 160 may be a Positive Temperature Coefficient (“PTC”) heater or other type of heater having an upper end 162 housing a controller and an opposing lower end 164. The heater channel 158 includes an upper heater opening 166 defined in and extending through the upper surface 28 of the upper shell 16 and a divider heater opening 168 (shown in FIG. 1) defined in and extending through the divider 18. The divider heater opening 168 is substantially parallel to the upper heater opening 166 when the upper shell 16 is installed on the divider 18. Each of the upper heater opening 166 and the divider heater opening 168 define a substantially similar profile complementary to a cross-sectional outer profile of the heater 160, such that the heater 160 may be inserted through the upper heater opening 166 and the divider heater opening 168. A heater channel axis 170 is defined by the heater channel 158 and extends from the upper heater opening 166, through the divider heater opening 168, to the lower surface 20 of the lower shell 14.

During assembly of the HVAC system 10, the heater 160 is inserted into the heater channel 158 along the heater channel axis 170. The lower end 164 of the heater 160 is inserted into the upper heater opening 166 and moved downward toward the divider heater opening 168. The heater 160 is then further inserted into the heater channel 158 as the lower end 164 is inserted through the divider heater opening 168 and moved downward toward the lower surface 20 of the lower shell 14, which may not include a corresponding opening. When the heater 160 is fully inserted into the heater channel 158, the lower end 164 of the heater 160 engages the lower surface 20 and the upper end 162 of the heater 160 is disposed proximate the upper heater opening 166.

According to another exemplary embodiment, the lower end 164 of the heater 160 is disposed in and engages a corresponding feature in the lower surface 20 of the lower shell 14. The housing assembly 12 is then assembled about the heater 160. For example, the divider heater opening 168 is aligned with the upper end 162 of the heater 160 and the divider 18 is moved downward from the upper end 162 toward the lower shell 14. The upper heater opening 166 of the upper shell 14 is then aligned with the upper end 162 of the heater 160 and moved downward the divider 18 until the connector assembly 100 couples the upper shell 16, divider 18, and the lower shell 14.

As shown in FIG. 9, the heater 160 is installed in the substantially the same direction as the fasteners 152. For example, the heater 160 may be installed in a first, downward direction from the upper shell 16 toward the lower shell 14 and the fasteners 152 may be installed in the same direction from the upper flange 134 toward the lower flange 106. In this configuration, the heater channel axis 170 may be substantially parallel to the longitudinal axes 110, 128, 138. Notably, by installing the heater 160 in the housing assembly 12 in the same direction as the fasteners 152 are installed, the HVAC system 10 may be assembled without reorienting the housing assembly 12 before inserting the heater 160 therein. This configuration reduces the stress on the operator and improves efficiency and cost for assembling the HVAC system 10.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure. Specifically, while the present application refers to the terms “upper” and “lower,” it should be understood that these terms define a spatial relationship between two corresponding components (e.g., the upper and lower shells 16, 14) relative to each other but do not limit the orientation of the upper and lower shells 16, 14 relative to other components during assembly. These terms further do not limit the orientation of the housing assembly 12 during installation in the HVAC system 10. For example, the housing assembly 12 may be assembled or installed in an orientation wherein the lower shell 14 is disposed above the upper shell 16.

It is to be understood that although the present invention has been described with regard to preferred embodiments thereof, various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, structures, shapes and proportions of the various elements, mounting arrangements, orientations, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A housing assembly for an HVAC system comprising:
a first shell comprising a first boss including a first bore configured to receive a fastener therein;
a second shell comprising an second boss including an second bore; and
a divider disposed between the first shell and the second shell, the divider including a divider bore configured to receive the first boss therein and a divider counterbore configured to receive the second boss therein;
wherein a diameter of the divider bore is less than a diameter of the divider counterbore; and
wherein the divider bore and the divider counterbore are coaxial and configured to receive the fastener extending therethrough.

2. The housing assembly of claim 1, further comprising a heater disposed in the housing assembly;
wherein the heater comprises a heater controller disposed proximate the second shell.

3. The housing assembly of claim 1, wherein the first shell and the second shell engage the divider with a tongue-and-groove configuration.

4. The housing assembly of claim 1, wherein:
a connector assembly comprises the first boss, the second boss, and the divider bore; and
wherein the housing assembly comprises a plurality of connector assemblies.

5. A housing assembly for an HVAC system comprising:
a first shell comprising a first boss;
a second shell comprising a second boss; and
a divider disposed between the first shell and the second shell, the divider comprising a divider flange defining a divider bore and a divider counterbore;
wherein one of the divider bore or divider counterbore is configured to receive the first boss;
wherein the other of the divider bore or the divider counterbore is configured to receive the second boss;
wherein a diameter of the divider bore is less than a diameter of the divider counterbore; and
wherein the divider bore and the divider counterbore are coaxial and configured to receive a fastener extending therethrough.

6. The housing assembly of claim 5, further comprising a first bore defined in the first boss and a second bore defined in the second boss;
wherein the first bore is configured to receive and threadably engage the fastener therein.

7. The housing assembly of claim 6, wherein the fastener extends from the second bore, through the divider bore and divider counterbore, into the first bore.

8. The housing assembly of claim 7, further comprising a shoulder extending radially inward into the second boss and defining a shoulder opening extending therethrough.

9. The housing assembly of claim 8, wherein the fastener comprises a head configured to engage the shoulder.

10. The housing assembly of claim 5, wherein:
the divider bore is configured to receive the first boss therein; and
the divider counterbore is configured to receive the second boss therein.

11. The housing assembly of claim 10, wherein:
the first boss defines a first boss outer diameter; and
the divider bore defines a divider bore diameter substantially the same as the first boss outer diameter.

12. The housing assembly of claim 11, wherein:
the first boss defines a first boss length and the divider bore defines a divider bore length less than the first boss length; and
at least a portion of the first boss is received in the second bore.

13. The housing assembly of claim 10, wherein:
the second boss defines a second boss outer diameter; and
the divider counterbore defines a divider counterbore diameter substantially the same as the second boss outer diameter.

14. A method of assembling an HVAC system comprising:
positioning a divider on a first shell, the first shell including a first boss;
positioning a second shell on the divider opposing the first shell, the second shell including a second boss;
inserting a fastener through the second boss then into the first boss; and
coupling the first shell, the divider, and the second shell with the fastener;
wherein a diameter of the divider bore is less than a diameter of the divider counterbore; and
wherein the divider bore and the divider counterbore are coaxial and configured to receive the fastener extending therethrough.

15. The method of claim 14, further comprising inserting a heater through a heater opening defined in the second shell and a divider heater opening defined in the divider.

16. The method of claim 15, wherein:
the heater is inserted through the heater opening and the divider heater opening along a heater channel axis;
the fastener is inserted through the second boss and the first boss along a longitudinal axis; and
wherein the heater channel axis is substantially parallel to the longitudinal axis.

17. The method of claim 14, further comprising threadably engaging the first boss with the fastener.

18. The method of claim 14, further comprising:
aligning the first boss with one of a divider bore or a divider counterbore defined by the divider; and
inserting the first boss into the one of the divider bore or divider counterbore.

19. The method of claim 18, further comprising:
aligning the second boss with the other of the divider bore or divider counterbore defined by the divider; and
inserting the second boss into the other of the divider bore or divider counterbore.

20. The method of claim 18, wherein the first boss is inserted into the one of the divider bore or divider counterbore before the divider engages the first shell.
